(19) United States
(12) Patent Application Publication
(10) Pub. No.: US 2003/0234916 A1
(43) Pub. Date: Dec. 25, 2003

(54) Soft supports to reduce deformation of vertically mounted lens or mirror

(75) Inventor: Douglas C. Watson, Campbell, CA (US)

Correspondence Address: BEYER WEAVER & THOMAS LLP, P.O. BOX 778, BERKELEY, CA, 94704-0778, US

(73) Assignee: Nikon Corporation, Tokyo (JP)

(21) Appl. No.: 10/443,599

(22) Filed: May 21, 2003

Related U.S. Application Data
(60) Provisional application No. 60/391,058, filed on Jun. 21, 2002.

(51) Int. Cl. G02B 7/02; G03B 27/42

(52) U.S. Cl. 355/53; 359/819

(57) ABSTRACT

A soft support for vertically mounting an optical element such as a lens or a mirror has one or more soft mounts each supporting the optical element from below at a peripheral position either vertically or radially and a plurality of position defining constraints that are more rigid that the soft mounts, each applying a peripheral tangential force on the optical element.

### BACKGROUND OF THE INVENTION

This invention relates to a vertical lens support, or more generally to a device for supporting an optical element such as a lens or a mirror vertically. In particular, this invention relates to a kinematic vertical lens support capable of reducing deformation of the vertically mounted lens or mirror.

Optical elements that are herein considered are those of an optical system having extremely high accuracy, precision and freedom from aberrations as well as the ability to make observations and exposures in ranges of wavelength outside the visible spectrum such as required in many manufacturing and scientific processes such as a lithographic exposure process.

It has been known to support such an optical element by means of many high-stiffness actuators such as PZT actuators, as described, for example, in U.S. Pat. No. 5,037,184 issued Aug. 6, 1991 to Ealey. These many actuators overconstrain the optical element, and overconstrained optical elements have disadvantages for precision control.

Deformable mirrors with low-stiffness force-type actuators for controlling deformation without overconstraint were disclosed by John Hardy (“Active Optics: A New Technology for the Control of Light,” IEEE, Vol. 60, No. 6 (1978)) but high-stiffness kinematic mounts are used for controlling the position in six degrees of freedom. Kinematically constrained optical elements with force actuators require some other means for controlling or adjusting the rigid body position.

A quasi-kinematic lens mounting assembly was disclosed in U.S. Pat. No. 6,239,924 issued May 29, 2001 to Watson, adapted to support a lens horizontally, so as to keep its optical axis in a vertical direction, on a set of mounting seats and also provided with a set of soft mounts for further distributing the gravitational load without overconstraining the lens.

For mounting such an optical element vertically, so as to keep its optical axis horizontally, it has been suggested to make use of an elongated flexible material to wrap half way around its circumference, or around the lower half of the generally circular peripheral surface. With this method of support, however, it is difficult to control local adjustments of its shape.

Moreover, the optical element to be supported may be very fragile, such as those comprising CaF₂. An excessively large clamping force thereon may damage it or cause intolerable deformations. Thus, it is desirable to reduce the clamping force as much as possible while maintaining friction force needed for supporting such an optical element.

### SUMMARY OF THE INVENTION

It is therefore an object of this invention to reduce deformation of a vertically mounted optical element such as a lens or a mirror, or to deform the lens or mirror in a desired way.

It is more particularly an object of this invention to provide a soft support for reducing deformation of a vertically mounted optical element.

Soft supports are called “soft” because they apply a force with low stiffness such that the force does not vary significantly with dimensional changes in the optical element or its mechanical mounting ring. A soft support embodying this invention for vertically mounting an optical element such as a lens or a mirror may be characterized broadly as including one or more soft mounts each supporting the optical element from a peripheral position either vertically, radially, tangentially, or in any direction, and a plurality of position defining constraints that are more rigid than the soft mounts. The position defining constraints may be three in number, evenly separated peripherally around the optical element, each constraining different two solid-body degrees of freedom of the motion of the optical element. Each of the soft mounts, whether applying its elastic vertically or radially, may comprise a coil spring, a pair of magnets or other low-stiffness force-generating means, and may further comprise an adjustment device such as a set screw to adjust the elastic force of the coil spring or the distance of separation between the pair of magnets.

The invention further relates to an EUV (extremely ultraviolet) system having such a soft support incorporated in its optical system for projecting a pattern on a wafer by a projection beam, as well as objects manufactured with such an EUV system and a wafer on which an image has been formed by such an EUV system.

### BRIEF DESCRIPTION OF THE DRAWING

The invention, together with further objects and advantages thereof, may best be understood with reference to the following description taken in conjunction with the accompanying drawings in which:

FIG. 1A is a schematic optical diagram of a representative embodiment of an X-ray microlithography system comprising at least one multilayer-film reflective optical element according to any of the embodiments of this invention, FIG. 1B is a detailed view of the projection-optical system of the microlithography system shown in FIG. 1A, and FIG. 1C is a schematic optical diagram of another representative embodiment of an X-ray microlithography system comprising at least one multilayer-film reflective optical element (including a reflective reticle) according to any of the embodiments of this invention;

FIG. 2 is a process flow diagram illustrating an exemplary process by which semiconductor devices are fabricated by using the apparatus shown in FIG. 1 according to the present invention;

FIG. 3 is a flowchart of the wafer processing step shown in FIG. 2 in the case of fabricating semiconductor devices according to the present invention;

FIG. 4 is a sectional view of a refracting lens as an example of optical element to be vertically mounted according to this invention;

FIG. 5 is a schematic front view of a soft support embodying this invention mounting a lens vertically;

FIG. 6 is a schematic drawing of an example of tangent constraint that may be a component of the soft support of FIG. 5; and

FIGS. 7-11 are schematic drawings of examples of soft mount that may be a component of the soft support of FIG. 5.

### DETAILED DESCRIPTION OF THE INVENTION

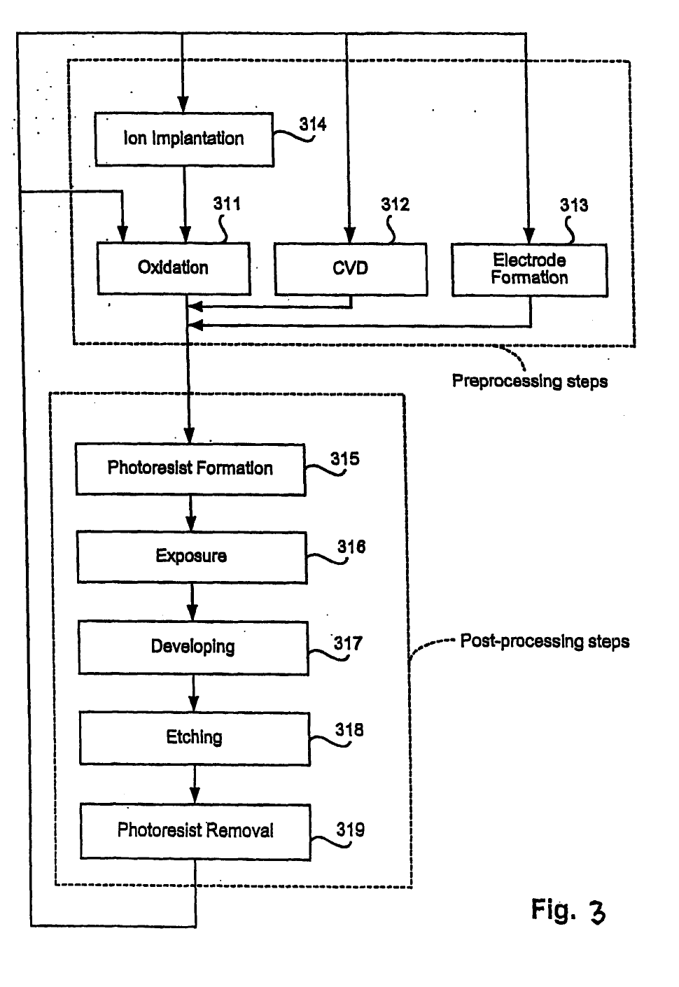

FIG. 4 shows a refracting lens 10 as an example of the optical element adapted to be supported by a lens mount of the present invention to be described in detail below, preferably including a circumferential flange 12 formed on a peripheral edge 14 thereof. Such a flange is not required but is advantageous in increasing the useful optical surface of the lens 10 and in substantially reducing optical deformation of the edge of the lens 10 due to mechanical clamping force. Conventionally, the lens is often clamped or secured on a peripheral surface portion 16 of the lens but this blocks the optical surface of the periphery of the lens and can deform the lens surface. Since the clamped lens surface is generally curved, furthermore, a clamp on a peripheral surface 16 can also impart a radial force on the lens, causing distortion. If the lens 10 is held and clamped on its circumferential flange 12, any deformation and distortion of the lens 10 and its optical path caused by the mechanical clamping can be minimized.

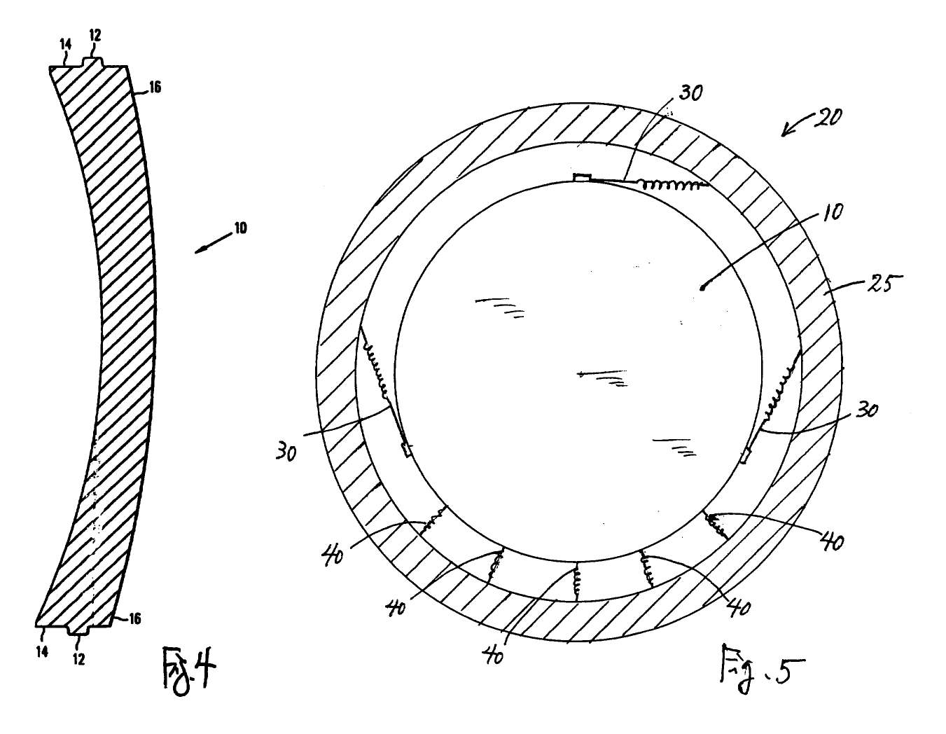

Vertical supports of this invention for an optical element such as a lens or a mirror may be characterized in most general terms as comprising a plurality of position-constraining means and one or more soft mounts supporting the optical element from below. FIG. 5 shows very schematically an example of vertical support 20 embodying this invention for an optical element such as a lens shown at 10 in FIG. 4 mounted in a cell 25. In this example, the position-constraining means consists of three relatively more rigid position constraining mounts 30, and there are five relatively less rigid soft mounts 40.

Each of these three position constraining mounts 30 is stiff tangentially and in the axial direction of the lens 10, thus being adapted to constrain the lens 10 in two degrees of freedom. The three position constraining mounts 30 are distributed around the periphery of the lens 10, spaced evenly as shown in FIG. 5. Thus, the three position constraining mounts 30 together constrain the lens 10 in its six solid-body degrees of freedom of displacement.

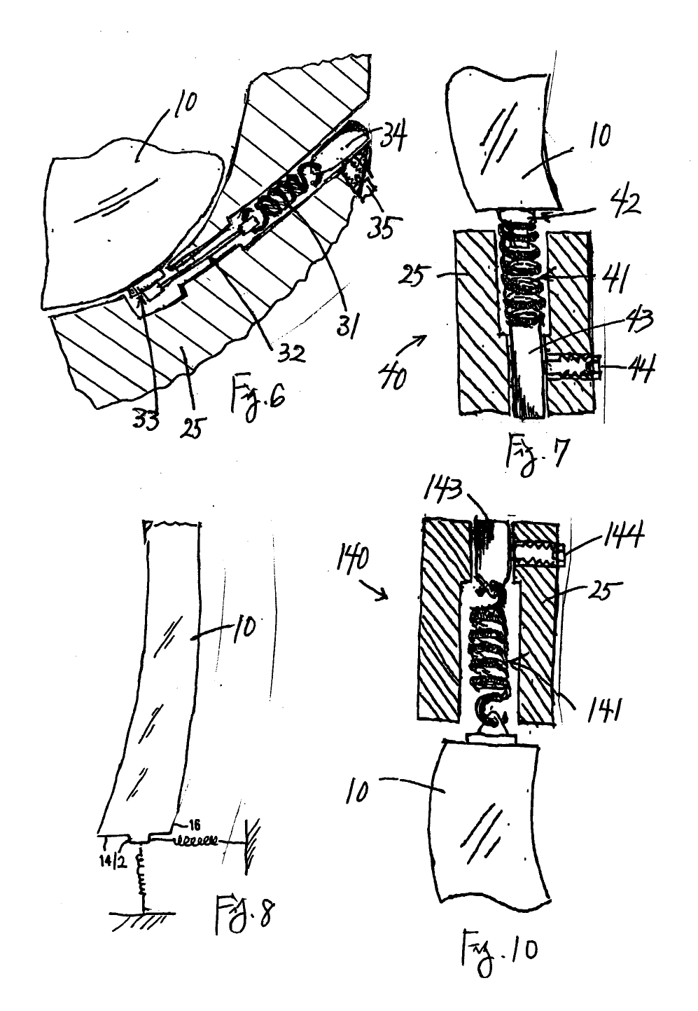

The invention is not limited by any particular way in which these mounts 30 should be formed. FIG. 6 shows an example of soft mount providing force in the tangential direction, comprising a spring 31 with one end connected through an elongated link 32 to a pad 33 bonded to the periphery of the lens 10, or its flange 12. The link 32 is longitudinally stiff and extends tangentially with respect to the lens 10. The other end of the spring 31 is attached to an adjustment shaft 34 provided with a set screw 35 for adjusting the elastic force of the spring 31.

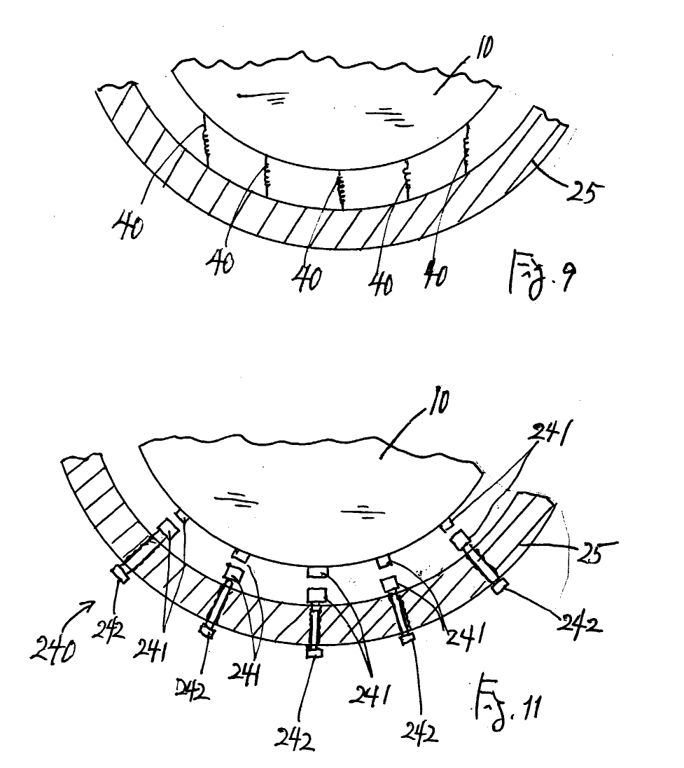

Neither is the invention limited by the way the soft mounts 40 are formed. FIG. 7 shows an example wherein the soft mount 40 comprises a compression spring 41 with one end applying a compressive force to the periphery of the lens 10 or to its flange 12 through a contact pad 42 which may be attached to the lens 10 by an adhesive or by adhesive bonding. The other end of the spring 41 contacts an adjustment shaft 43 similarly provided with a locking set screw 44 for adjusting the compressive force of the spring 41.

As set forth above, these examples are intended to be illustrative, not intended to limit the scope of the invention. Many modifications and variations are possible within the scope of the invention. Regarding the tangential constraints 30, their number is not limited to be three. Six tangential constraints, each constraining one degree of freedom, may be attached to the lens 10 at six different peripheral positions. As shown schematically in FIG. 8, a tangential constraint may be adapted to apply both a radial force and an axial force at a same point on the lens 10, one in the plane including the center of gravity of the lens 10 and the other out of such a plane. Such arrangements with combinations of forces may be advantageous, depending on the shape of the lens 10. Alternatively, radial and tangential forces may be applied at different locations along the axial direction of the lens 10. As still another example, although not illustrated, three tangential constraints may be used, one constraining three degrees of freedom, another constraining two degrees of freedom and the third constraining one degree of freedom such that altogether the six solid-body degrees of freedom of the lens 10 are constrained.

Regarding the soft mounts 40, although FIG. 5 shows an example wherein the five soft mounts 40 each exert a force in a radial direction with respect to the lens 10, they may be arranged to each apply a vertically upward force on the lens 10, as illustrated in FIG. 9. Although a soft mount using a compressive spring was shown in FIG. 7, a tension spring may be used in a soft mount. FIG. 10 shows an example of such soft mount 140 comprising a tension spring 141 with one end applying a tensile force to the periphery of the lens 10 or to its flange 12 to which it is attached and the other end engaging an adjustment shaft 143 similarly provided with a locking set screw 144 for adjusting the tensile force of the spring 141.

FIG. 11 shows another example with five soft mounts 240 each comprised of a pair of magnets 241 with poles of a same polarity facing each other such that the repulsive magnetostatic force therebetween serves to support the lens 10 against the gravitational force thereon. One of the magnets 241 of each pair is attached to an adjustment screw 242 such that the gap between each pair of the magnets 241 and hence the repulsive force therebetween can be adjusted. Although five pairs of magnets 241 are shown, each arranged radially, any number of pairs may be used and the pairs may be arranged vertically (although not separately illustrated).

Although not separately illustrated, soft mount mechanisms of other known kinds may be used for applying either a vertical or radial force and having low or zero stiffness in other directions such as tangential and axial directions. Examples of such other kinds of soft mount include those comprising a flat cantilever blade, a torsion spring or a bent or bowed blade spring. Where a plurality of soft mounts are used, as shown in FIGS. 5 and 9, their forces may be all equal or vary according to the position.

Regarding the adjustments of the soft mounts 40, 140 and 240, they may be adjusted such that 100% of the static weight of the lens 10 is supported thereby and hence that there is no static load on the tangential constraints 30 serving as position-constraining means. Alternatively, they may be adjusted so as to support only some fraction of the lens weight, some reaction force remaining at some or all of the position-constraining means. The invention does not prevent the soft mounts from supporting a weight greater than that of the lens 10. In such an application, some or all of the position-constraining means are reversed in direction.

In summary, all such modifications and variations that may be apparent to a person skilled in the art are intended to be included within the scope of this invention.

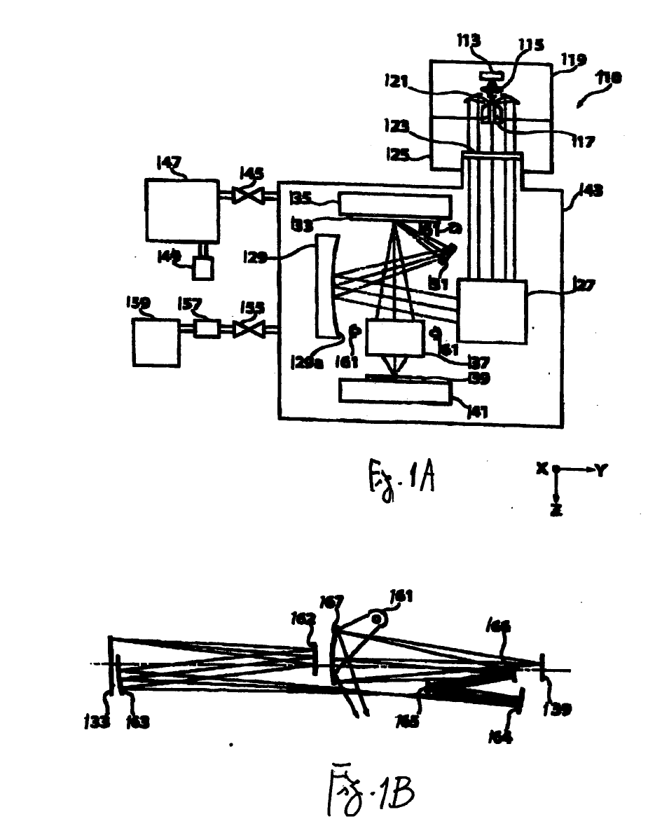

FIG. 1A shows an EUV (or soft-X-ray SXR) system 110, including the EUV mirror of this invention as described above. As a lithographic energy beam, the EUV system 110 uses a beam of EUV light of wavelength λ=13 nm. The depicted system is configured to perform microlithographic exposures in a step-and-scan manner.

The EUV beam is produced by a laser-plasma source 117 excited by a laser 113 situated at the most upstream end of the depicted system 110. The laser 113 generates laser light at a wavelength within the range of near-infrared to visible. For example, the laser 113 can be a YAG laser or an excimer laser. Laser light emitted from the laser 113 is condensed by a condensing optical system 115 and directed to the downstream laser-plasma source 117. Upon receiving the laser light, the laser-plasma source 117 generates SXR (EUV) radiation having a wavelength (λ) of approximately 13 nm with good efficiency.

A nozzle (not shown), disposed near the laser-plasma source 117, discharges xenon gas in a manner such that the discharged xenon gas is irradiated with the laser light in the laser-plasma source 117. The laser light heats the discharged xenon gas to a temperature sufficiently high to produce a plasma that emits photons of EUV light as the irradiated xenon atoms transition to a lower-potential state. Since EUV light has low transmittance in air, the optical path for EUV light propagating from the laser-plasma source 117 is contained in a vacuum chamber 119 normally evacuated to high vacuum. Since debris normally is produced in the vicinity of the nozzle discharging xenon gas, the vacuum chamber 119 desirably is separate from other chambers of the system.

A parabolic mirror 121, coated with a Mo/Si multilayer film, is disposed relative to the laser-plasma source 117 so as to receive EUV light radiating from the laser-plasma source 117 and to reflect the EUV light in a downstream direction as a collimated beam. The multilayer film on the parabolic mirror 121 is configured to have high reflectivity for EUV light of which λ=approximately 13 um.

The collimated beam passes through a visible-light-blocking filter 123 situated downstream of the parabolic mirror 121. By way of example, the filter 123 is made of Be, with a thickness of 0.15 nm. Of the EUV radiation reflected by the parabolic mirror 121, only the desired 13-nm wavelength of radiation passes through the filter 123. The filter 123 is contained in a vacuum chamber 125 evacuated to high vacuum.

An exposure chamber 143 is disposed downstream of the filter 123. The exposure chamber 143 contains an illumination-optical system 127 that comprises a condenser mirror and a fly-eye mirror (not shown, but well understood in the art). The illumination-optical system 127 also is configured to trim the EUV beam (propagating from the filter 123) to have an arc-shaped transverse profile. The shaped “illumination beam” is irradiated toward the left in the figure.

A circular, concave mirror 129 is situated so as to receive the illumination beam from the illumination-optical system 127. The concave mirror 129 has a parabolic reflective surface 129a and is mounted perpendicularly in the vacuum chamber 143. The concave mirror 129 comprises, for example, a quartz mirror substrate of which the reflection surface is machined extremely accurately to the desired parabolic configuration. The reflection surface of the mirror substrate is coated with a Mo/Si multilayer film so as to form the reflective surface 129a that is highly reflective to EUV radiation of which λ=13 nm. Alternatively, for other wavelengths in the range of 10-15 nm, the multilayer film can be of a first substance such as Ru (ruthenium) or Rh (rhodium) and a second substance such as Si, Be (Beryllium) or B₄C (carbon tetraboride).

A mirror 131 is situated at an angle relative to the concave mirror 129 so as to received the EUV beam from the concave mirror 129 and direct the beam at a low angle of incidence to a reflective reticle 133. The reticle 133 is disposed horizontally so that its reflective surface faces downward in the figure. Thus, the beam of EUV radiation emitted from the illumination-optical system 127 is reflected and condensed by the concave mirror 129, directed by the mirror 131, and focused don the reflective surface of the reticle 133.

The reticle 133 includes a multilayer film so as to be highly reflective to incident EUV light. A reticle pattern, corresponding to the pattern to be transferred to a substrate 139, is defined in an EUV-absorbing layer formed on the multiplayer film of the reticle 133, as discussed later below. The reticle 133 is mounted to a reticle stage 135 that moves the reticle 133 at least in the Y direction. The reticle 133 normally is too large to be illuminated entirely during a single exposure “shot” of the EUV beam. As a result of the mobility of the reticle stage 135, successive regions of the reticle 133 can be irradiated sequentially so as to illuminate the pattern in a progressive manner with EUV light from the mirror 131.

A projection-optical system 137 and substrate (such as a semiconductor wafer) 139 are disposed in that order downstream of the reticle 133. The projection-optical system 137 comprises multiple multilayer-film reflective mirrors that collectively demagnify an aerial image of the illuminated portion of the pattern on the reticle 133. The demagnification normally is according to a predetermined demagnification factor such as ¼. The projection-optical system 137 focuses an aerial image of the illuminated pattern portion onto the surface of the substrate 139. Meanwhile, the substrate 139 is mounted to a substrate stage 141 that is movable in the X, Y, and Z directions.

Connected to the exposure chamber 143 via a gate valve 145 is a preliminary-evacuation (“load-lock”) chamber 147. The load-lock chamber 147 allows exchanges of the reticle 133 and/or substrate 139 as required. The load-lock chamber 147 is connected to a vacuum pump 149 that evacuates the load-lock chamber 147 to a vacuum level substantially equal to the vacuum level inside the exposure chamber 143.

During a microlithographic exposure, EUV light from the illumination-optical system 127 irradiates the reflective surface of the reticle 133. Meanwhile, the reticle 133 and substrate 139 are moved by their respective stages 135 and 141 in a synchronous manner relative to the projection-optical system 137. The stages 135 and 141 move the reticle 133 and the substrate 139, respectively, at a velocity ratio determined by the demagnification factor of the projection-optical system 137. Thus, the entire circuit pattern defined don the reticle 133 is transferred, in a step-and-scan manner, to one or more “die” or “chip” locations on the substrate 139. By way of example, each “die” or “chip” on the substrate 139 is a square having 25-mm sides. The pattern is thus “ transferred” from the reticle 133 to the substrate at very high resolution (such as sufficient to resolve a 0.07-μm line-and-space (L/S) pattern). So as to be imprintable with the projected pattern, the upstream-facing surface of the substrate 139 is coated with a suitable “resist.”

In the system 110 of FIG. 1A at least one multilayer-film optical element as described above is included in at least one of the illumination-optical system 127, the reticle 133, and the projection-optical system 137.

The system 110 also comprises a means for introducing an oxygen-containing gas into the exposure chamber 143 in the vicinity of the multilayer-film mirror(s) as EUV radiation is impinging on the multilayer-film mirror(s). As shown in FIG. 1A, the oxygen-containing gas is supplied from gas reservoir 159, from which the gas is introduced into the exposure chamber 143 via a flow-control meter 157 and valve 155.

Inside the exposure chamber 143 and situated adjacent the multilayer-film mirror(s) are one or more lamps 161 that produce a catalysis-energizing light having a wavelength of 400 nm or less and an energy level of, desirably, 3 eV or greater. For example, the light produced by the lamps 161 can be visible light, ultraviolet light, or EUV light. Light from a lamp 161 is directed so as to irradiate a reflective surface of at least one multilayer-film mirror, and serves to accelerate the photocatalytic reaction occurring on and in the respective protective layer(s).

It will be understood that the lamp(s) 161 are not necessary. Catalysis can be energized sufficiently in many instances using light normally used for performing microlithography. For example, the energizing light can be supplied by an EUV—light source such as the laser-plasma source 117. Alternatively or in addition, one or more lamps 161 can be used. If lamps 161 are employed, a respective lamp 161 need not be provided for each multilayer-film mirror in the system. Rather, certain multilayer-film mirror(s) can be selected for enhanced irradiation by the energizing wavelength, using a respective lamp(s). Thus, using the lamp(s) 161, the removal of hydrocarbon molecules adsorbed onto the protective layer(s) can be enhanced relative to a situation in which lamp(s) 161 are not used. In other words, a lamp 161 desirably is used to increase the amount of energizing wavelength impinging on the subject multilayer-film mirror, relative to the amount of light normally impinging on the mirror from the laser-plasma source 117.

If a sufficient amount of the oxygen-containing gas is provided to the location being irradiated by the energizing wavelength, then the photocatalysis reactions (having rates that are proportional to the intensity of the energizing wavelength of light) progress rapidly. Even if there is an uneven distribution of the intensity of energizing-wavelength light on the surface of a multilayer-film mirror, removal of contaminant such as carbon progresses rapidly at locations at which the rate of contaminant deposition is rapid. Contaminant removal is slower at locations at which the contaminant-deposition rate is relatively slow. Thus, it is possible to prevent contaminant deposition and to facilitate contaminant removal across the entire reflective surface of the mirror.

The projection-optical system 137 normally comprises multiple multilayer-film mirrors. An especially advantageous use of lamp(s) 161 is in association with the multilayer-film mirror situated closest to the substrate 139. FIG. 1B depicts certain details of an exemplary projection-optical system 137 that comprises six multilayer-film mirrors 162, 163, 164, 165, 166 and 167. The beam of EUV light reflected from the reticle 133 is reflected by the multilayer-film mirrors 162, 163, 164, 165, 166 and 167 in that order. From the last mirror 167 the EUV light reaches the substrate 139 and forms an image of the illuminated reticle pattern on the substrate 139. In the projection-optical system of FIG. 1B, a lamp 161 is provided near the multilayer-film mirror 167 (situated closest to the substrate 139 and thus is the last mirror to reflect EUV light). The lamp 161 is arranged such that light from it (having a wavelength of 400 nm or less) irradiates the reflective surface of the multilayer-film mirror 167. The lamp 161 is provided because: (1) the reflective surface of the multilayer-film mirror 167 faces the substrate; (2) the mirror 167 is the last mirror that reflects the EUV lithography beam, and so the intensity of the EUV lithography beam is lowest at the mirror 167; and (3) because of (1) and (2), it is difficult to remove contamination from the mirror 167 by using only the EUV light beam. The lamp 161 is situated such that light therefrom does not reflect toward the substrate 139.

As the mirror 167 is being irradiated by light from the lamp 161, an oxygen-containing gas (such as a gas comprising one or more selected from oxygen, water vapor and hydrogen peroxide) is introduced into the exposure chamber 143 from the reservoir 159 via the flow controller 157 and valve 155. The partial pressure of this gas in the exposure chamber 143 is, for example, 1×10⁻⁸ Torr.

In a comparison example, a multilayer-film mirror lacking the protective layer was used (instead of the mirror 167 in the system of FIG. 1A). After 100 hours of use under actual exposure conditions, the surface of the comparison-example mirror became oxidized significantly. The oxidation caused the projection-optical system 137 (comprising the mirror 167) to exhibit a decrease in reflectivity of sufficient magnitude to reduce the amount of EUV light reaching the substrate 139 to approximately half its initial intensity (at the beginning of the 100-hour period). In contrast, in an evaluation example, the multilayer-film mirror 167 included a protective layer, as described above. After 100 hours' use under actual exposure conditions, no decrease in the amount of light reaching the substrate 139 was observed, indicating that the evaluation-example mirror 167 remained free of surface oxidation.

As described above, a multilayer-film mirror is provided with a protective layer formed of a photocatalytic material. The protective layer is the uppermost layer of the multilayer film. By introducing an oxygen-containing gas (such as oxygen, water vapor and hydrogen peroxide) into the atmosphere surrounding the mirror and irradiating the protective surface with light having a wavelength of 400 nm or less, the gas produces oxygen radicals by a photocatalytic reaction involving the photocatalytic material in the protective layer. Hydrocarbon molecules adsorbed on the protective layer react with the oxygen radicals and produce carbon dioxide gas, which is evacuated readily by using a vacuum pump.

As noted above, multilayer-film reflective optical elements according to an aspect of the invention are not limited to multilayer-film mirrors. Examples of multilayer-film reflective optical element include reflective reticles as used, for example, for defining a pattern used in EUV projection microlithography.

FIG. 1C shows another embodiment of an X-ray (specifically EUV) microlithography system utilizing one or more multilayer-film reflective optical elements as described herein. This system is similar to one disclosed in the U.S. Pat. No. 6,266,389 issued Jul. 24, 2001, which is herein incorporated by reference. The system depicted in FIG. 1C comprises the EUV source S, an illumination-optical system (comprising elements GI and IR1-IR4), a reticle stage MST for holding a reticle M, a projection-optical system (comprising elements PR1-PR4) and a substrate stage WST for holding a substrate W (such as a semiconductor wafer).

The EUV source S generates an illumination beam IB of EUV light. To such end, a laser LA generates and directs a high-intensity laser beam LB (near-IR to visible) through a lens L to the discharge region of a nozzle T that discharges a target substance such as xenon. The irradiated target substance forms a plasma that emit photons of EUV light that constitute the illumination beam IB. The illumination beam IB is reflected by a parabolic multilayer-film mirror PM to a window W1. The EUV source S is contained in a chamber C1 that is evacuated to a suitably high vacuum by means of a vacuum pump (not shown). The illumination beam IB passes through the window W1 to the interior of an optical-system chamber C2.

The illumination beam IB then propagates to the illumination-optical system comprising mirrors GI, IR1, IR2, IR3 and IR4. The mirror GI is a grazing-incidence mirror that reflects the grazing-incident illumination beam 113 from the EUV source S. (Alternatively, the mirror GI can be a multilayer-film mirror.) The mirrors IR1, IR2, IR3 and IR4 are multilayer-film mirrors each including a surface multilayer film exhibiting high reflectivity to incident EUV radiation, as described elsewhere herein. The illumination-optical system also comprises a filter (not shown) that is transmissive only to EUV radiation of a prescribed wavelength. The illumination-optical system directs the illumination beam IB, having the desired wavelength, to a selected region on the reticle M. The reticle M is a reflective reticle including a multilayer film and protective layer, as described above. The beam reflected from the reticle M carries an aerial image of the illuminated region of the reticle M; hence the reflected beam is termed a patterned beam.

The protection-optical system comprises multiple multilayer-film mirrors PR1, PR2, PR3 and PR4 that collectively project an image of the illuminated portion of the reticle M onto a corresponding location on the substrate W. Thus, the pattern defined by the reticle M is transfer-exposed onto the substrate W. Note that several of the mirrors PR1-PR4 (specially the mirrors PR1 and PR4) have a cutout allowing the patterned beam unobstructed passage in the projection-optical system. So as to be imprintable with the projected pattern, the substrate W is coated with an exposure-sensitive resist. Since EUV radiation is absorbed and attenuated in the atmosphere, the environment in the optical-system chamber C2 is maintained at a suitably high vacuum (such as 10⁻⁵ Torr or less). Actual exposure of the substrate W can be performed in a “step-and-repeat,” “step-and-scan,” or pure s canning-exposure manner, or other suitable manner, all of which involving controlled movements of the reticle stage MST and substrate stage WST relative to each other as transfer-exposure of the pattern progresses. During exposure, the substrate W is situated in a separate chamber C3, termed a “substrate chamber” or “wafer chamber,” that contains the substrate stage WST. As the patterned beam PB enters the substrate chamber C3 from the optical-system chamber C2, the beam passes through a window W2.

As noted above, the reticle M (as well as any of the multilayer-film mirrors) of the system of FIG. 1C includes a protective layer (that includes a photocatalytic material) formed over at least a portion of the multilayer film. As visible, ultraviolet or EUV light (from the illumination beam IB or from a separate source) irradiates the reticle M in the presence of an oxygen-containing gas, any carbon contamination adhering to the surface of the multilayer film is decomposed. Thus, the rate and extent of reticle contamination can be reduced substantially compared to conventional systems, thereby reducing pattern-transfer failure and contrast degradation, as well as extending the useful life of the reticle.

The use of exposure apparatus provided herein is not limited to a photolithography system for a semiconductor manufacturing. Exposure apparatus, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device, when far ultra-violet rays such as the excimer laser is used, glass materials such as quartz and fluorite that transmit far ultra-violet rays is preferably used. When the F₂ type laser or x-ray is used, optical device should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

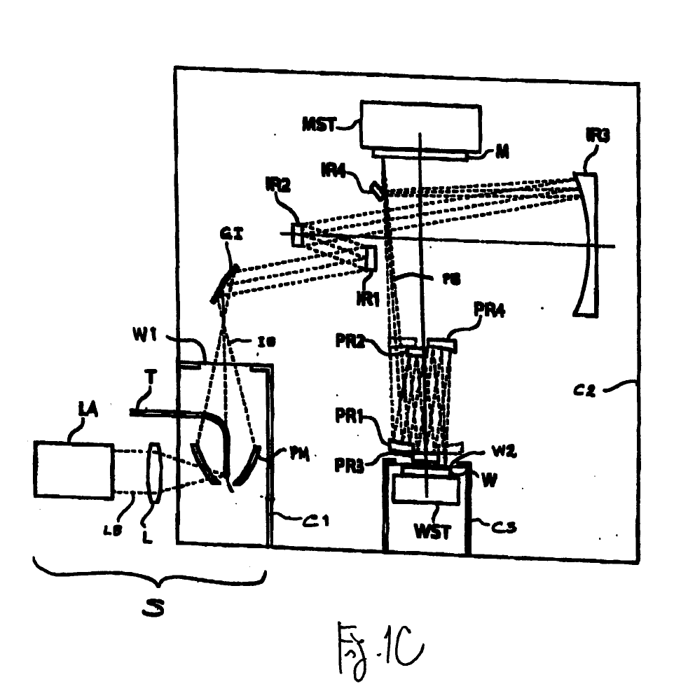

Further, semiconductor devices can be fabricated using the above described systems, by the process shown generally in FIG. 2. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

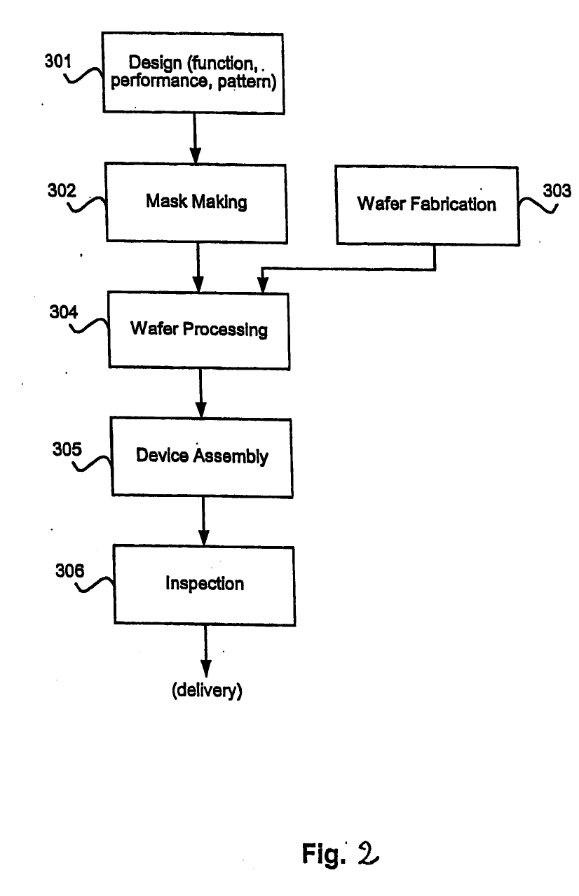

FIG. 3 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

While a lithography system of this invention has been described in terms of several preferred embodiments, there are alterations, permutations, and various substitute equivalents which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A soft support for vertically mounting an optical element, said support comprising:
one or more soft mounts each supporting said optical element at a peripheral position; and
a plurality of position defining constraints each applying a peripheral tangential force on said optical element, said soft mounts being less rigid than said position defining constraints.

2. The soft support of claim 1 comprising three position defining constraints that are evenly separated peripherally around said optical element to control six solid body degrees of freedom of said optical element.

3. The soft support of claim 1 comprising three position defining constraints each constraining different two solid body degrees of freedom of said optical element.

4. The soft support of claim 1 wherein each of said position defining constraints comprises a coil spring that applies an elastic force.

5. The soft support of claim 4 wherein each of said position defining constraints further comprises an adjustment device for adjusting said elastic force.

6. The soft support of claim 1 wherein each of said soft mounts exerts a vertical force on said optical element.

7. The soft support of claim 1 wherein each of said soft mounts exerts a radial force on said optical element.

8. The soft support of claim 1 wherein each of said soft mounts comprises a coil spring that applies an elastic force.

9. The soft support of claim 8 wherein each of said soft mounts further comprises an adjustment device for adjusting said elastic force.

10. The soft support of claim 1 wherein each of said soft mounts comprises a pair of magnets that apply a repulsive force on each other.

11. The soft support of claim 10 wherein each of said soft mounts further comprises an adjustment device for adjusting said repulsive force.

12. An EUV system comprising:
an EUV radiation source;
a reticle stage arranged to retain a reticle;
a working stage arranged to retain a workpiece; and
an optical system for guiding radiation from said radiation source to project an image of said reticle on said workpiece, said optical system including an optical element and a soft support vertically mounting said optical element;
wherein said soft support includes:
one or more soft mounts each supporting said optical element at a peripheral position; and
a plurality of position defining constraints each applying a peripheral tangential force on said optical element, said soft mounts being less rigid than said position defining constraints.

13. An object manufactured with the EUV system of claim 12.

14. A wafer on which an image has been formed by the EUV system of claim 12.

15. A method for making an object using a lithography process, wherein the lithography process utilizes an EUV system as recited in claim 12.

16. A method for patterning a wafer using a lithography process, wherein the lithography process utilizes an EUV system as recited in claim 12.
